(19) United States
(12) Patent Application Publication
(10) Pub. No.: US 2012/0104232 A1
(43) Pub. Date: May 3, 2012

(54) IMAGE SENSOR HAVING SUB-SAMPLING FUNCTION

(75) Inventor: Won Seok HWANG, Icheon (KR)

(73) Assignee: HYNIX SEMICONDUCTOR INC., Icheon-si (KR)

(21) Appl. No.: 13/285,154

(22) Filed: Oct. 31, 2011

(30) Foreign Application Priority Data
Nov. 1, 2010 (KR) 10-2010-0107625

(51) Int. Cl. H01L 27/146

(52) U.S. Cl. 250/208.1

(57) ABSTRACT

An image sensor includes, inter alia, a pixel array, read-out circuit blocks, and switching units. The pixel array includes unit pixels arranged in rows and columns. Two or more read-out circuit blocks sample, amplify, and perform analog-to-digital conversion on unit pixel data to read image data of the pixel array. The switching units establish connection between column lines of the pixel array and the read-out circuit blocks. The switching units establish connection between the column lines of the pixel array and the read-out circuit blocks such that data of all of the sampled pixels in a sub-sampling mode is processed by less than all of the read-out circuit blocks.

### CROSS-REFERENCE TO RELATED APPLICATIONS

This application claims priority to Korean Patent Application No. 10-2010-0107625 filed on Nov. 1, 2010, in the Korean Intellectual Property Office, the disclosure of which is incorporated herein by reference in its entirety.

### BACKGROUND OF THE INVENTION

1. Field of the Invention

The present invention relates generally to an image sensor and, more particularly, to an image sensor having a pixel data sub-sampling function with low power consumption.

2. Description of the Related Art

An image sensor includes a pixel array to capture an image by using the light reactive semiconductor qualities. For example, a pixel array in a CMOS image sensor is arranged in a matrix form in rows and columns. Each pixel includes a photodiode for sensing light and some transistors associated with the photodiode. The pixel array outputs an analog signal, which is to be converted into a digital signal through an analog-to-digital converter (ADC) in a read-out circuit. The converted digital signal is stored in a line memory. The data stored in the line memory is sequentially transferred to an image signal processor through a memory bus according to the column address thereof.

FIG. 1 shows a prior art example of a CMOS image sensor 100. The image sensor 100 includes a pixel array 110 converting the light energy into electrical energy. A correlated double sampling (CDS)/column decoder 120 cancels the fixed pattern noise from the pixels and decodes the column addresses. A programmable gain amplifier/analog-to-digital converter PGA/ADC circuit 130 amplifies an analog image signal and converts the amplified analog signal into a digital image signal. A row decoder 140 decodes the row addresses. A row driver 150 selects the rows of the pixel array 110 in response to a corresponding signal from the row decoder 140. A controller 160 controls the circuits 120, 130, 140, 150. The PGA/ADC circuit 130 samples the data of the pixels under the control of the controller 160. A read-out circuit for reading the data of the selected pixels includes the CDS/column decoder 120 connected to the respective columns of the pixel array 110 and the PGA/ADC circuit 130.

A sub-sampling function, which operates to increase the frame rate and to reduce the size of an output image, is provided in most of the image sensor applications. In a sub-sampling mode, unlike a normal mode, only a portion of the data of the entire pixel array is extracted to create a new image having a resolution lower than that of a normal mode image. For example, a 100×100 pixel array image in a normal mode may be sub-sampled by quarter (¼) to create a 50×50 pixel array image.

In an image sensor having a multi-channel read-out circuit, each channel may be equipped with a PGA/ADC block, and the pixel data may be sampled through the plurality of PGA/ADC blocks overall. The image sensor having such a multi-channel read-out circuit supports sub-sampling through address decoding while operating all of the channels. Thus, even in a sub-sampling mode, all analog circuits (e.g., the CDS circuit, the PGA/ADC circuit, or the like) associated with the respective channels of the read-out circuit are required to be operated. As a result, the sub-sampling mode cannot obtain gain with respect to power consumption of the image sensor.

### SUMMARY OF THE INVENTION

An aspect of the present invention provides, inter alia, an image sensor capable of reducing power consumption of a read-out circuit in a sub-sampling mode.

According to an aspect of the present invention, there is provided an image sensor including: a pixel array including a plurality of unit pixels arranged in rows and columns; two or more read-out circuit blocks sampling, amplifying and performing analog-to-digital conversion on unit pixel data to read image data of the pixel array; and switching units establishing a connection between column lines of the pixel array and the respective read-out circuit blocks, wherein the switching units establish a connection between the column lines of the pixel array and the read-out circuit blocks such that data of all of the sampled pixels in a sub-sampling mode is processed by only some of the two or more read-out circuit blocks. In the sub-sampling mode, power supply to remaining read-out circuit blocks, among the two or more read-out circuit blocks, may be cut off.

The two or more read-out circuit blocks include a first read-out circuit block and a second read-out circuit block, and the switching units may include a first switching block, connecting the first read-out circuit block to the pixel array, and a second switching block, connecting the second read-out circuit block to the pixel array.

The switching unit may establish a connection between the column lines of the pixel array and the read-out circuit blocks such that all of the pixels sampled in the sub-sampling mode are processed by only the first read-out circuit block. In the sub-sampling mode, power supply to the second read-out circuit block may be cut off.

The first switching block may include a plurality of column select switches connecting corresponding odd numbered column lines or even numbered column lines to the first read-out circuit block in response to an odd numbered column select signal or an even numbered column select signal. The column select switches of the first switching block may connect one of a (2n+1)th column line (n is an integer of 0 or greater) and a (2n+2)th column line to the first read-out circuit block.

The second switching block may include a plurality of column select switches connecting corresponding odd numbered column lines or even numbered column lines to the second read-out circuit block in response to an odd numbered column select signal or an even numbered column select signal. The column select switches of the second switching block may connect one of a (2n+1)th column line (n is an integer of 0 or greater) and a (2n+2)th column line to the second read-out circuit block.

Each of the read-out circuit blocks may include: at least one correlated double sampling (CDS) block performing correlated-double-sampling on an output signal from the unit pixels; and at least one analog front end (AFE) block amplifying an analog image signal output from the CDS block and converting the amplified analog image signal into a digital image signal. Each AFE block may include a programmable gain amplifier (PGA) amplifying the analog image signal and an analog-to-digital converter (ADC) converting the amplified signal into a digital signal.

Each CDS block may be shared by two contiguous column lines. Also, each of the read-out circuit blocks may include a plurality of CDS blocks and a plurality of AFE blocks, and here, each of the AFE blocks may be shared by two or more CDS blocks.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 shows a prior art example of a CMOS image sensor;

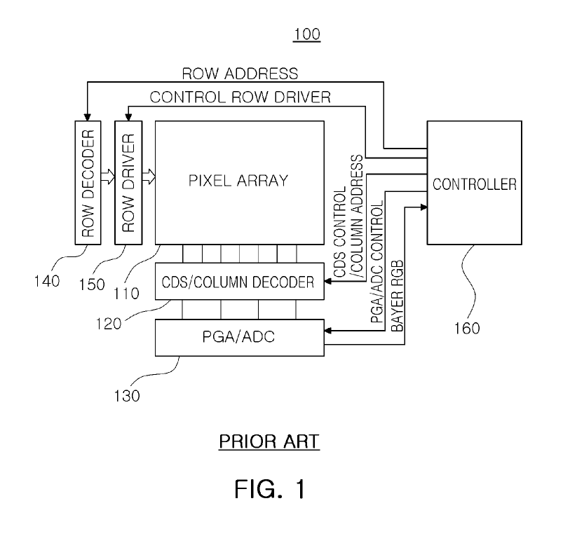

FIG. 2 shows an image sensor according to an embodiment of the present invention related to a sampling mode; and

FIG. 3 shows an image sensor according to an embodiment of the present invention related to a normal mode.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

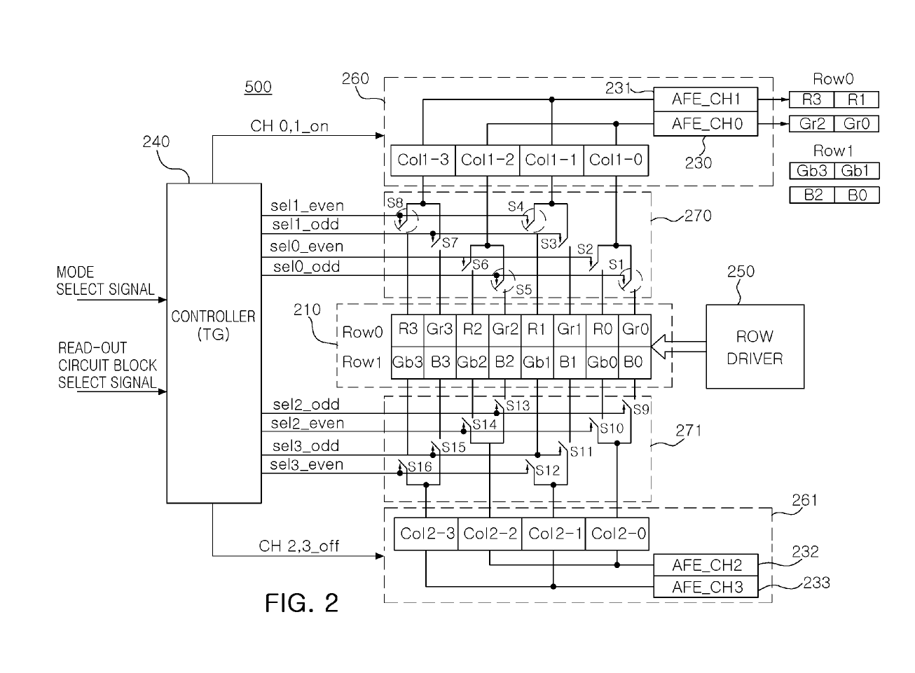

FIG. 2 shows an image sensor having a sampling mode function according to an embodiment of the present invention. An image sensor 500 includes a pixel array 210, read-out circuit blocks 260, 261, and switching units 270, 271 establishing the connections between the pixel array 210 and the read-out circuit blocks 260, 261.

The pixel array 210 includes a plurality of unit pixels arranged in rows and columns. In particular, the pixel array 210 (including three types of pixels, i.e., red pixels R0, R1, R2, R3; blue pixels B0, B1, B2, B3; and green pixels Gr0, Gr1, Gr2, Gr3, Gb0, Gb1, Gb2, Gb3) has a Bayer pattern pixel arrangement. FIG. 2 shows the pixel array having two rows and eight columns as an embodiment of the present invention, but it should be readily understood that the present invention may be applicable to a pixel array having a different number of rows and columns.

A row driver 250 selects a row line of the pixel array 210 in response to a row address signal from a row decoder (not shown). For example, the row driver 250 may sequentially select the row lines Row0 and Row1 of the pixel array 210. When the first row line Row0 is selected, the pixels Gr0, R0, Gr1, R1, Gr2, R2, Gr3, R3 of the first row are activated, and, when a second row line Row1 is selected, pixels B0, Gb0, B1, Gb1, B2, Gb2, B3, Gb3 of the second row are activated.

Two or more read-out circuit blocks 260, 261 are circuits for reading the image data of the pixel array 210. The read-out circuit blocks 260, 261 sample unit pixel data of the pixel array 210, amplify the sampled signal, and convert the amplified analog signal into a digital signal. The respective read-out circuit blocks 260, 261 includes at last one correlated double sampling (CDS) block and at least one analog front end (AFE) block. The CDS block correlate-double-samples an output signal of the unit pixels to cancel the fixed pattern noise that may be present in the unit pixels. The AFE block amplifies an analog image signal outputted from the CDS block and converts the amplified analog image signal into a digital signal.

In an embodiment of the present invention, the first read-out circuit block 260 includes a plurality of CDS blocks Col1-0, Col1-1, Col1-2, Col1-3 and a plurality of AFE blocks AFE CH1 230, AFE CH2 231. The second read-out circuit block 261 includes a plurality of CDS blocks Col2-0, Col2-1, Col2-2, Col2-3 and a plurality of AFE blocks AFE CH2 232, AFE CH3 233. Each of the AFE blocks 230, 231, 232, 233 may include a programmable gain amplifier (PGA) amplifying an analog image signal and an ADC converting the amplified signal into a digital signal. As shown in FIG. 2, each of the CDS blocks may be shared by two contiguous row lines. For example, as illustrated, the CDS block Col1-0 may be shared by the first row line (Gr0, B0) and the second row line (R0, Gb0).

In an embodiment of the present invention, each of the AFE blocks are shared by two or more CDS blocks, and two or more CDS blocks sharing one AFE block may be driven at mutually different timings. The respective AFE blocks 230, 231, 232, 233 form a channel for reading pixel data. Thus, the image sensor 500 is directed to a multi-channel image sensor having a plurality of read channels. For example, the first read-out circuit block 260 includes the AFE block 230 of a first channel and the AFE block 231 of a second channel, and the second read-out block 261 includes the AFE block 232 of a third channel and the AFE block 233 of a fourth channel. The AFE block 230 of the first channel is shared by two CDS blocks Col1-0, Col1-2 and the AFE block 231 of the second channel is shared by the other two CDS blocks Col1-1, Col1-3. Also, the AFE block 232 of the third channel is shared by two CDS blocks Col2-0, Col2-2 and the AFE block 233 of the fourth channel is shared by the other two CDS blocks Col2-1, Col2-3.

The switching units 270, 271 establish connection between the column lines of the pixel array 210 and the respective read-out circuit blocks 260, 261. A switching controller 240 controls a connection operation of the switching units 270, 271 through odd number column select signals sel0_odd, sel1_odd and even number column select signals sel0_even, sel1_even. In particular, in a sub-sampling mode, the switching units 270, 271 may establish a connection between the column lines and the read-out circuit blocks such that only channels of one (or some) of the two or more read-out circuit blocks 260, 261 are selected, and the sampled pixel data is processed only through the selected read-out circuit block(s).

For example, in a sub-sampling mode, the switching units 270, 271 may connect the pixel array 210 and the read-out circuit blocks 260 and 261 such that all of the sampled pixel data is processed by only the first read-out circuit block 260 but not by the second read-out circuit block 261. The switching units 270, 271 include a first switching block 270 and a second switching block 271. The first switching block 270 establishes connection between the first read-out circuit block 260 and the pixel array 210, and the second switching block 271 establishes connection between the second read-out circuit block 261 and the pixel array 210.

Each of the switching blocks 270, 271 may include a plurality of column select switches S1˜S8, S9˜S16, respectively. As illustrated, in the first switching block 270, the column select switches S1˜S8 may be classified into odd number column select switches S1, S3, S5, S7, and even number column select switches S2, S4, S6, S8. The odd number column select switches S1, S3, S5, S7 connect corresponding odd number column lines to the first read-out circuit block 260 in response to odd number column select signals sel0_odd, sel1_odd. The even number column select switches S2, S4, S6, S8 connect corresponding even number column lines to the first read-out circuit block 260 in response to the even number column select signals sel0_even, sel1_even. The mutually contiguous odd number column lines and even number column lines may be grouped by two's to share one CDS block.

For example, the first column line (Gr0, B0) and the second column line (R0, Gb0) share one CDS block Col1-0. The column select switches S1˜S8 may connect one of a (2n+1)th column line (n is an integer of 0 or greater) and a (2n+2)th column line to the first read-out circuit block 260 at the same timing. For example, the column select switches S1, S2 may operate to connect one of the two column lines (Gr0, B0), (R0, Gb0) to the first read-output circuit block 260, in particular, to the CDS block Col1-0 at the same timing. The column select switches S3, S4 may operate to connect one of two column lines (Gr1, B1), (R1, Gb1) to the CDS block Col1-1 at the same timing.

The second switching block 271, including the plurality of column select switches S9-S16 in the same manner as described above, connects a corresponding even number column line or odd number column line to the second read-out circuit block 271 in response to odd number column line select signals sel2_odd, sel3_odd or even number column select signals sel2_even, sel3_even. Also, in the second switching block 271, the column select switches S9˜S16 may connect one of the (2n+1)th column line (n is an integer of 0 or greater) and the (2n+2)th column line to the second read-out circuit block 271 at the same timing.

An example of an image sensor operation in the sub-sampling mode will be described in detail with reference to FIG. 2.

When the first row0 is selected by the row driver 250, the odd number column select signal sel0_odd for a connection to the AFE block 230 of the first channel becomes high (i.e., is changed into a high level signal) to connect the column select switch S1 of the first column line to the CDS block Col1-0 and the first channel AFE block 230 of the first read-out circuit block 260. Also, the even number column select signal sel1_even becomes high to connect the column select switch S4 of the fourth column line to the CDS block Col1-1 and the second channel AFE block 231 of the first read-out circuit block 260. Accordingly, the data of the pixel Gr0 is provided to the first channel AFE block 230 of the first read-out circuit block according to the connection of the switch S1, and the data of the pixel R1 is provided to the second channel AFE block 231 of the first read-out circuit block 260 according to the connection of the switch S4.

While the first row Row0 is being selected, at a different timing, the odd number column select signal sel0_odd becomes high to connect the column select switch S5 of the fifth column line to the CDS block Col1-2 and the first channel AFE block 230 of the first read-out circuit block 260. Also, the even number column select signal sel1_even becomes high to connect the column select switch S8 of the fifth column line to the CDS block Col1-3 and the second channel AFE block 231 of the first read-out circuit block 260. Accordingly, the data of the pixel Gr2 is provided to the first channel AFE block 230 of the first read-out circuit block 260 according to the connection of the switch S5, and the data of the pixel R3 is provided to the second channel AFE block 231 of the first read-out circuit block 260 according to the connection of the switch S8.

When the second row Row1 is selected by the row driver 250, the odd number column select signal sel0_odd becomes high to connect the column select switch S1 of the first column line to the CDS block Col1-0 and the first channel AFE block 230 of the first read-out circuit block 260. Also, the even number column select signal sel1_even becomes high to connect the column select switch S4 of the fourth column line to the CDS block Col1-1 and the second channel AFE block 231 of the first read-out circuit block 260. Accordingly, the data of the pixel B0 is provided to the first channel AFE block 230 of the first read-out circuit block according to the connection of the switch S1, and the data of the pixel Gb1 is provided to the second channel AFE block 231 of the first read-out circuit block 260 according to the connection of the switch S4.

While the first row Row0 is being selected, at a different timing, the odd number column select signal sel0_odd becomes high to connect the column select switch S5 of the fifth column line to the CDS block Col1-2 and the first channel AFE block 230 of the first read-out circuit block 260. Also, the even number column select signal sel1_even becomes high to connect the column select switch S8 of the fifth column line to the CDS block Col1-3 and the second channel AFE block 231 of the first read-out circuit block 260. Accordingly, the data of the pixel B2 is provided to the first channel AFE block 230 of the first read-out circuit block 260 according to the connection of the switch S5, and the data of the pixel Gb3 is provided to the second channel AFE block 231 of the first read-out circuit block 260 according to the connection of the switch S8.

As described above, in a sub-sampling mode according to an embodiment of the present invention, the image sensor 500 samples the pixels Gr0, R1, Gr2, R3 at the first row Row0, and samples the pixels B0, Gb1, B2, Gb3 at the second row Row1. All of the pixels Gr0, R1, Gr2, R3, B0, Gb1, B2, Gb3 sampled in the sub-sampling mode are provided to the first channel or second channel AFE blocks 230 or 231. Accordingly, all of the pixel data sampled in the sub-sampling mode are processed by only the first read-out block 260, rather than by the second read-out circuit block 261. The number of channels (two channels) operating through the switching units 270, 271 in the sub-sampling mode is smaller than the number of channels (four channels) actually operating in the normal mode. In a sub-sampling mode according to an embodiment of the present invention, the second read-out circuit block 261 may not operate so as to cut off the power supply to the second read-out circuit block 261. In this manner, since the power supply to the non-operating second read-out circuit block 261 is turned off, the power consumption of the image sensor can be effectively reduced. For example, according to an embodiment of the present invention as shown in FIG. 2, when the power supply to one of the read-out circuit blocks 260, 261 is cut off in the sub-sampling mode, the power consumed by the read-out circuit blocks 260, 261 is reduced by about half. And this leads to reduction in the overall power consumption of a product using the image sensor.

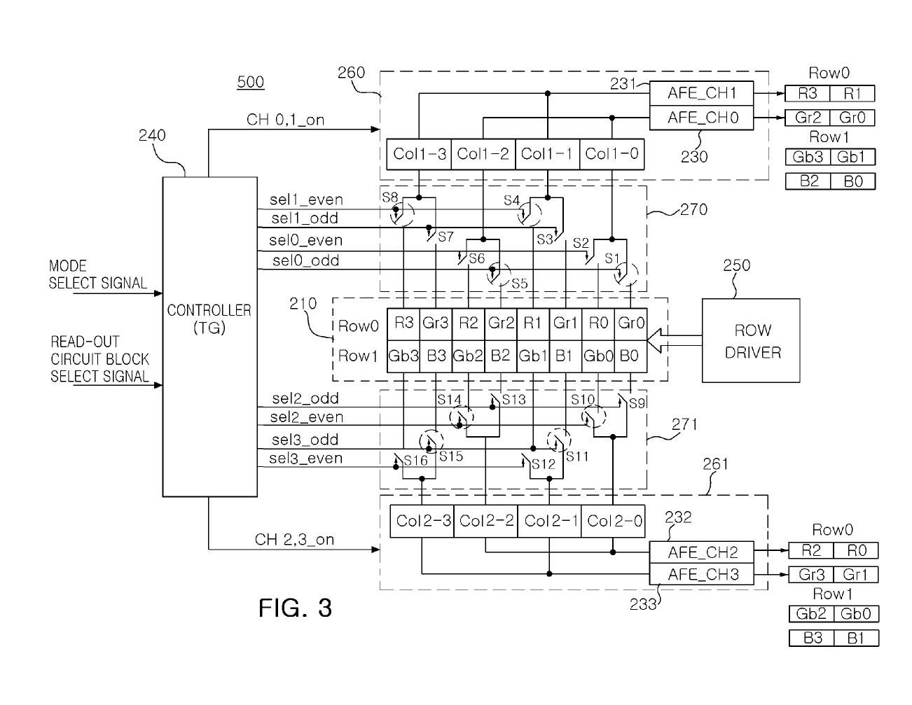

An example of a normal mode operation of the image sensor 500 will now be described with reference to FIG. 3. As shown in FIG. 3, when the first row Row0 is selected by the row driver 250, the switch S1 is closed by the column select signal sel0_odd to provide data of the pixel Gr0 to the first channel AFE block 230 of the first read-out circuit block 260, and the switch S4 is closed by the column select signal sel1_even to provide data of the pixel R1 to the second channel AFE block 231 of the first read-out circuit block 260. Also, the switch S10 is closed by the column select signal sel2_even to provide data of the pixel R0 to the third channel AFE block 232 of the second read-out circuit block 261 and the switch S11 is closed by the column select signal sel3_odd to provide data of the pixel Gr1 to the fourth channel AFE block 233 of the second read-out circuit block 261.

While the first row Row0 is being selected, at a different timing, the switch S5 is closed by the column select signal sel0_odd to provide data of the pixel Gr2 to the first channel AFE block 230 of the first read-out circuit block 260, and the switch 8 is closed by the column select signal sel1_even to provide data of the pixel R3 to the second channel AFE block 231 of the first read-out circuit block 260. Also, the switch S14 is closed by the column select signal sel2_even to provide data of the pixel R2 to the third channel AFE block 232 of the second read-out circuit block 261, and the switch S15 is closed by the column select signal sel3_odd to provide data of the pixel Gr3 to the fourth channel AFE block 233 of the second read-out circuit block 261.

When the second row Row1 is selected by the row driver 250, the switch S1 is closed by the column select signal sel0_odd to provide data of the pixel B0 to the first channel AFE block 230 of the first read-out circuit block 260, and the switch S4 is closed by the column select signal sel1_even to provide data of the pixel Gb1 to the second channel AFE block 231 of the first read-out circuit block 260. Also, the switch S10 is closed by the column select signal sel2_even to provide data of the pixel Gb0 to the third channel AFE block 232 of the second read-out circuit block 261, and the switch S11 is closed by the column select signal sel3_odd to provide data of the pixel B1 to the fourth channel AFE block 233 of the second read-out circuit block 261.

While the second row Row1 is being selected, at a different timing, the switch S5 is closed by the column select signal sel0_odd to provide data of the pixel B2 to the first channel AFE block 230 of the first read-out circuit block 260, and the switch 8 is closed by the column select signal sel1_even to provide data of the pixel Gb3 to the second channel AFE block 231 of the first read-out circuit block 260. Also, the switch S14 is closed by the column select signal sel2_even to provide data of the pixel Gb2 to the third channel AFE block 232 of the second read-out circuit block 261, and the switch S15 is closed by the column select signal sel3_odd to provide data of the pixel Gr3 to the fourth channel AFE block 233 of the second read-out circuit block 261.

As described above, in a normal mode according to an embodiment of the present invention, the image sensor 500 samples all of the pixels Gr0, R0, Gr1, R1, Gr2, R2, Gr3, R3, B0, Gb0, B1, Gb1, B2, Gb2, B3, Gb3 of a Bayer pattern. The pixel data sampled in the normal sampling mode is provided to several channels 230, 231, 232, 233 of the first and second read-out circuit blocks 260, 261 so as to be processed.

While the present embodiment has been described with reference to certain embodiments, it will be understood by those skilled in the art various changes may be made and equivalents may be substituted without departing form the scope of the present invention. In addition, many modifications may be made to adapt a particular situation or material to the teachings of the present invention without departing from its scope. For example, ½ sub-sampling is illustrated in FIG. 2, but the present invention may also be applicable to sub-samplings of different multiples, such as ¼ sub-sampling. Also, the sub-sampling mode of FIG. 2 and the normal mode of FIG. 3 are merely illustrative, and can be naturally replaced by a different system or an operation mode equivalent thereto, and, also in such a case, the data of all of the sub-sampled pixels may be processed by only some of a plurality of read-out circuit blocks, rather than being processed by the remaining read-out circuit blocks. Power of non-operating read-out circuit blocks may be turned off to thus effectively reduce power consumption in the process of reading pixel data of the image sensor.

As set forth above, according to embodiments of the invention, power supplied to the read-out circuit blocks of channels not used in the sub-sampling mode is turned off, thereby effectively reducing power consumption in sub-sampling. Thus, the use of the image sensor can lead to power saving in a product using the image sensor. Namely, the stored power of a product using the image sensor can be saved.

While the present invention has been shown and described in connection with the embodiments, it will be apparent to those skilled in the art that modifications and variations can be made without departing from the spirit and scope of the invention as defined by the appended claims.

What is claimed is:

1. An image sensor comprising:
a pixel array comprising a plurality of unit pixels arranged in rows and columns;
two or more read-out circuit blocks sampling unit pixel data to read image data of the pixel array; and
switching units establishing a connection between column lines of the pixel array and the read-out circuit blocks,
wherein, in a sub-sampling mode, the switching units establish a connection between the column lines of the pixel array and the read-out circuit blocks such that the sampling is performed by less than all of the read-out circuit blocks.

2. The image sensor of claim 1, wherein, in the sub-sampling mode, power supply to the read-out circuit blocks that were not connected to the column lines by the switching units is cut off.

3. The image sensor of claim 1,
wherein the two or more read-out circuit blocks comprise:
a first read-out circuit block; and
a second read-out circuit block, and
wherein the switching units comprise:
a first switching block configured to connect the first read-out circuit block to the pixel array; and
a second switching block configured to connect the second read-out circuit block to the pixel array.

4. The image sensor of claim 3, wherein, in a sub-sampling mode, the switching unit establishes a connection between the column lines of the pixel array and the read-out circuit blocks such that all of the pixels sampled are processed by less than all read-out circuit blocks comprising the first read-out circuit block.

5. The image sensor of claim 4, wherein, in the sub-sampling mode, power supply to the read-out circuit blocks comprising the second read-out circuit block that were not connected to the column lines by the switching unit is cut off.

6. The image sensor of claim 3, wherein the first switching block comprises:
a plurality of column select switches connecting a plurality of odd numbered column lines or a plurality of even numbered column lines to the first read-out circuit block in response to an odd numbered column select signal or an even numbered column select signal, respectively.

7. The image sensor of claim 6, wherein the second switching block comprises:
a plurality of column select switches connecting a plurality of odd numbered column lines or a plurality of even numbered column lines to the second read-out circuit block in response to an odd numbered column select signal or an even numbered column select signal, respectively.

8. The image sensor of claim 1, wherein the sampled data is amplified and analog-to-digital converted.

9. The image sensor of claim 8, wherein each of the read-out circuit blocks comprises:
at least one correlated double sampling (CDS) block performing correlated-double-sampling on an output signal from the unit pixels; and
at least one analog front end (AFE) block amplifying an analog image signal output from the CDS block and converting the amplified analog image signal into a digital image signal.

10. The image sensor of claim 9, wherein each AFE block comprises:
a programmable gain amplifier (PGA) amplifying the analog image signal; and
an analog-to-digital converter (ADC) converting the amplified signal into a digital signal.

11. The image sensor of claim 9, wherein each CDS block is shared by two contiguous column lines.

12. The image sensor of claim 9, wherein each of the read-out circuit blocks comprises:
a plurality of CDS blocks; and
a plurality of AFE blocks, wherein each of the AFE blocks is shared by two or more CDS blocks.
